(19) United States
(12) Patent Application Publication
(10) Pub. No.: US 2025/0349060 A1
(43) Pub. Date: Nov. 13, 2025

(54) MANAGED TEXT ANIMATION EFFECTS

(71) Applicant: Apple Inc., Cupertino, CA (US)

(72) Inventors: Jacob G. REFSTRUP, San Jose, CA (US); Elliot A. BARER, Sunnyvale, CA (US); Christian KIENLE, Cupertino, CA (US)

(21) Appl. No.: 19/204,469

(22) Filed: May 9, 2025

Related U.S. Application Data
(60) Provisional application No. 63/647,073, filed on May 13, 2024.
(60) Provisional application No. 63/657,965, filed on Jun. 9, 2024.

(51) Int. Cl. G06T 13/80; G06F 3/0482; G06F 3/04842

(52) U.S. Cl. CPC G06T 13/80; G06F 3/0482; G06F 3/04842; G06T 2200/24

(57) ABSTRACT

Aspects of the subject technology provide for applying text effects to a text input or to a received message. The text effects applied to a text input may be applied automatically based on one or more words entered as text input. The text effects may be suggested. The text effects may be applied using an effects menu. Playback of text effects in a message transcript include animating text effects in succession from a start of a transcript or a start of a newly received message until the end of the transcript or message. Playback may be repeated after a delay which can be lengthened with each repetition.

### CROSS REFERENCE TO RELATED APPLICATIONS

This application claims the benefit of U.S. Provisional Application No. 63/647,073, entitled “MANAGED TEXT ANIMATION EFFECTS,” filed May 13, 2024, and U.S. Provisional Application No. 63/657,965, entitled “MANAGED TEXT ANIMATION EFFECTS,” filed Jun. 9, 2024, the entirety of which are incorporated herein by reference.

### TECHNICAL FIELD

The present description relates generally to electronic devices, including, for example, utilizing an electronic device to compose and send a message that includes text with an animation effect applied.

### BACKGROUND

The advancement of technology has brought about increased features in communication applications which can lead to a more user-friendly experience or enjoyment of user devices.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a diagram of various example electronic devices that may implement aspects of the subject technology in accordance with one or more implementations.

FIG. 2 illustrates a data flow diagram for data at a device implementing aspects of the subject technology, in accordance with one or more implementations.

FIGS. 3A and 3B illustrates flow diagrams of an example system for animated text effects, in accordance with one or more implementations.

FIGS. 4A, 4B, 4C, 4D1, 4D2, 4D3, and 4E illustrate examples of a user interface at various intermediate stages in the providing and selecting of a text effect, in accordance with one or more implementations.

FIG. 5 illustrates a process flow for implementing aspects of the subject technology in accordance with some implementations.

FIG. 6 illustrates a process flow for implementing aspects of the subject technology in accordance with some implementations.

FIG. 7 illustrates a chart of possible animated effects, in accordance with some implementations.

FIG. 8 illustrates examples of a connected script undergoing an interpolated transform process.

FIG. 9 illustrates interpolated transform data, in accordance with some implementations.

FIG. 10A illustrates an example electronic system with which aspects of the subject technology may be implemented in accordance with one or more implementations. FIGS. 10B and 10C illustrate flow diagrams for an application process implementing aspects of the disclosure, in accordance with some implementations. FIGS. 10D and 10E illustrate a device diagram and a system diagram, each of which implement aspects of the disclosure, in accordance with some implementations. FIGS. 10F and 10G illustrate a flow for an API calling module and API interface, which may be used in accordance with some implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Many people utilize handheld and other portable devices every day for their convenience and for sending and receiving messages from others. Messaging applications installed on such devices may include a composition interface having an input element for inserting text via a keyboard-type input or via a pasting action. Generally, the formatting of text messages has been limited. Spaces and line breaks can be used, but the words themselves cannot be formatted even to bold, italicize, or underline words.

The subject technology provides users with the ability to associate effects to words in their messages. Effects can include static effects like bold, italics, and underline effects or dynamic effects which animate a word, cause the word to have a motion characteristic over a time period. In one or more implementations, different types of effects can be combined and/or different effects of the same type may be combined. For example, multiple static effects can be combined (e.g., bold and underlined), one or more static effects and one or more dynamic effects (e.g., animation effect on an underlined text), and multiple dynamic effects (e.g., two different animations applied sequentially or simultaneously) can be combined. In one or more implementations, a user may select among a set of defined static and defined dynamic effects.

The subject technology can provide multiple mechanisms to apply an effect to one or more words in a text input. In one aspect, the text can be analyzed by pattern matching processing, by natural language processing (NLP), or by a machine learning model (MLM) to determine words in the text that are appropriate for applying an effect based on their typical use or their contextual use. For example, when a user inputs “That concert was amazing,” pattern matching can be used to determine to apply an effect to the word “amazing,” for example, as a way of emphasizing it.

Further, the pattern matching may also have associated a particular effect with pattern matched words. Pattern matching can also include support for word tagging. For example, text can be tagged by the user for an effect when the user uses special characters or patterns in entering their text. For example, when a user inputs “I don't know if I can make it to the *concert*,” tagging the word concert with asterisks may be found by pattern matching to apply an effect, suggest one or more effects, or tag the word so that it can be selected for applying an effect from an effects menu.

NLP can be used to determine if any words entered demonstrate a human emotion that may wish to be emphasized and may associate an effect to the word(s). In one or more implementations, an MLM can be locally trained at a user device by taking user data as training inputs to the MLM. Subsequently entered text can be submitted to the MLM for a prediction on which word(s) are candidates for applying an effect and for a prediction on which effect should be applied. When the user sends the message, the message can be used as further training data, creating a feedback for training data. When using pattern matching, NLP, or MLM, the word may include a group of words, such as a short phrase, like “way to go!”

When a word is determined to be a candidate for having an effect applied, the effect may automatically be applied to the word, a suggestion for an effect related to the word may be provided, or the word may be marked so that the user can select the word to bring up an effects menu based on selecting the word.

In another aspect of the subject technology, a user may select a word and choose an effects menu to choose an effect to apply to the selected word. The word may be selected by tapping the text input near word to position a cursor in or next to the word. The word may be selected by using select control elements to select the word (or a group of words). Upon selecting a word, an effects suggestion element of a user interface can provide suggestions for effects, or a user can select an effects menu for more effects options. The effects menu can show live previews of each of the available effects applied to the word so that the word is displayed according to each effect.

When an effect is applied to a word (or a group of words), the subject technology also may execute the effects on the words so that the words are displayed according to the effect applied, for example, in a message transcript. When the effects are static, the effects may be permanently applied. When the effects are dynamic, applying the effect means to execute the effects on the words. The execution may be performed periodically. For example, each effect can be executed on the corresponding word associated with the effect in succession, beginning at a top of the displayed message transcript. Effects may be executed in a variety of ways. In one aspect, each effect can be executed simultaneously and repeatedly. The repetition of each execution of the effect can be delayed so that the effect executes periodically. In another aspect, each effect may be executed serially (one after another), except that some overlap may occur between consecutive effect executions, and when the last effect in the message transcript is executed, the execution of the effects can begin again from the top. Users may be able to pause or cancel the execution of the effects or other action may cause the execution of the effects to pause or cancel.

The subject technology also provides, when a language or font of the word is a connected script, executing the effects on the fonts so that the connected parts of the scripts stay connected during the animation by utilizing an interpolated transform relating to the script.

The subject technology also provides, as a mechanism for providing the animating associated with the effects, using a compositor to move word clusters which are not being animated to accommodate the animation. In other words, the word clusters can be moved without the need to provide an animation related to the moving of the words, thereby saving processing and battery power.

Therefore, the subject technology advantageously provides a technological solution for applying effects, e.g., animating, to select words in a text input and in a text transcript. The subject technology advantageously reduces time, processing resources, memory resources, and/or battery resources by providing effects which would otherwise need to be separately accessed by the user, copied or saved by the user, and then separately selected by the user in composition of a message in a messaging application.

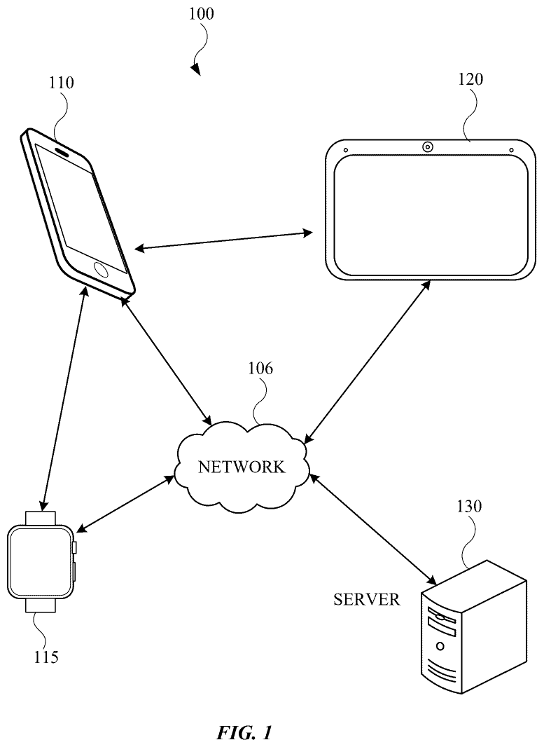

FIG. 1 illustrates an example network environment 100 in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes an electronic device 110, an electronic device 115, an electronic device 120, and a server 130. The network 106 may communicatively (directly or indirectly) couple the electronic devices 110-120 and/or the server 130. In one or more implementations, the network 106 may be an interconnected network of devices that may include, or may be communicatively coupled to, the Internet. For explanatory purposes, the network environment 100 is illustrated in FIG. 1 as including the electronic device 110, the electronic device 115, the electronic device 120, and the server 130; however, the network environment 100 may include any number of electronic devices and any number of servers or a data center including multiple servers. In some implementations one or more of the electronic devices 110-120 may not be connected to the network 106, but may be tethered to one of the other electronic devices 110-120 wirelessly or by a wired connection.

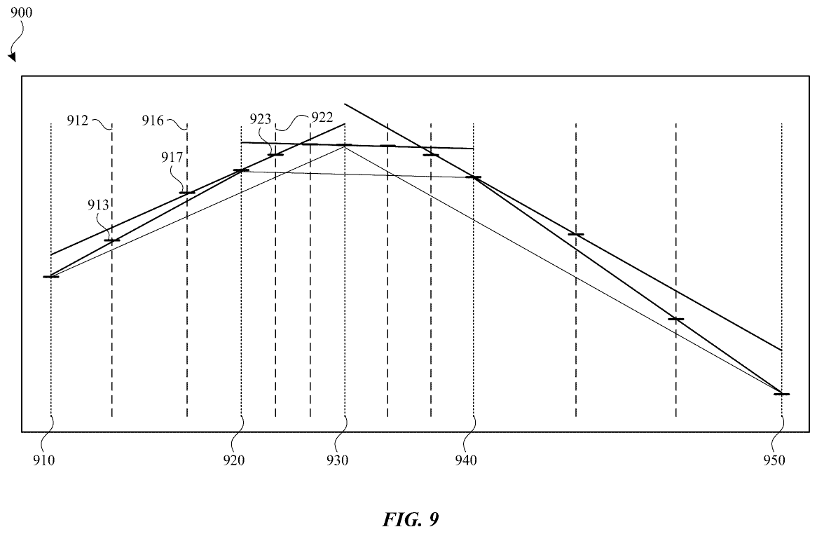

Each of the electronic devices 110-120 may be, for example, a desktop computer, a portable computing device such as a laptop computer, a smartphone, a peripheral device (e.g., a digital camera, headphones), a tablet device, a wearable device such as a watch, head mounted display, and the like. In FIG. 1, by way of example, the electronic device 110 is depicted as a mobile electronic device (e.g., smartphone), the electronic device 115 is depicted as a smart watch, and the electronic device 120 is depicted as a tablet computer. The electronic device 110, the electronic device 115, and the electronic device 120 may be, and/or may include all or part of, the electronic system discussed below with respect to FIG. 9.

In one or more implementations, one or more of the electronic devices 110-120 may provide a messaging application for composing and sending a message to another electronic device 110-120, for example, via a server 130. In one or more implementations, the sending electronic device 110-120 can send a message including text. The sending electronic device 110-120 can provide options to a user for selecting and applying effects to one or more words in the text, as described herein. The sending electronic device 110-120 can submit the message to the server 130, which can forward the message to a receiving electronic device 110-120 which can display the message in a corresponding messaging application, including the effects by applying the effects to the word or words associated with the effects. In one or more implementations, operations that involve individually identifiable information of a user of one or more of the electronic devices 110-120 may be performed securely or use encryption on the electronic devices 110-120, to prevent exposure of individually identifiable data to devices and/or systems that are not authorized by the user.

The server 130 may form all or part of a network of computers or a group of servers, such as in a cloud computing or data center implementation. For example, the server 130 stores data and software, and includes specific hardware (e.g., processors, graphics processors and other specialized or custom processors) for rendering and generating content such as graphics, images, video, audio and multimedia files. In an implementation, the server 130 may function as a messaging server that transmits messages content generated by the above-discussed electronic devices 110-120 and/or the server 130 to another of the above-discussed electronic devices 110-120.

In the example of FIG. 1, each of the electronic devices 110-120 are depicted as a particular type of device, e.g., smartphone, smart watch, tablet. However, it is appreciated that each of the electronic devices 110-120 may be implemented as another type of device, such as a wearable device (e.g., a smart watch or other wearable device). The electronic devices 110-120 may be a device of a user (e.g., the electronic devices 110-120 may be associated with and/or logged into a user account for the user at a server).

Each of the electronic devices 110-120, may include a body or housing containing elements such as input interfaces, output interfaces, processors, displays, processor(s), storage, system memory, read-only memory, network interfaces, and so forth, such as depicted in the electronic system discussed below with respect to FIG. 9.

To the extent that a single electronic device 110 is referenced herein, for the sake of simplicity, it is appreciated that any of the electronic devices of FIG. 1 may be utilized.

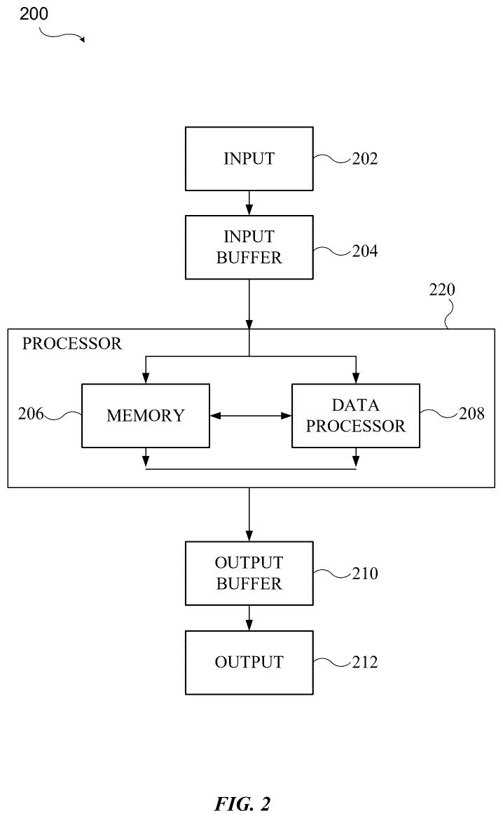

FIG. 2 illustrates data flow 200 in a device used for processing data in accordance with one or more implementations. Typical processing of data (e.g., at the electronic device 110) begins when the data is received at an input 202 and processed into an input buffer 204. The data is then transferred to a processor 220, where it is processed, and output to the output 212.

The processor 220 may include a memory 206 and a data processor 208. Depending on specific implementations, the processor 220 may also include other processors such as, for example, a graphics processor (which is not explicitly shown in FIG. 2). Thus, based on the type of device, the data processor 208 may perform, among other things, compression and/or decompression of the received data, encrypt the received data for storage, modulate or demodulate the received data, and/or perform other data manipulation.

In some implementations, each of the electronic devices 110, 115, and 120, and server 130 can include the data flow of FIG. 2. In some implementations such as a smartwatch or other secondary device, processing power, memory, and/or battery constraints may make it so that it is preferred for data processing of the message (e.g., compression or encryption) to be performed on another device, such as the electronic device 110, for example, by sending or receiving messages through the electronic device 110 to the server 130.

In some implementations, because of the environment in which the electronic devices functions, the processor 220 may have limited processing resources and/or storage resources outside the processor 220 may be limited. Processing resources can include a processing unit (e.g., CPU), FPGA, ASIC, hardware electronic circuit, etc. For example, in some implementations, thousands of instances of data processing (e.g., a data encryption and/or data decrypting) may need to be performed at the same time within given memory constraints. In some implementations, the processing resources of the processor 220 include a memory 206 which may be used as a cache or to provide a data buffer for certain data processing algorithms. Storage resources outside the processing resources may include other volatile or non-volatile memory.

For example, in some implementations, while processing the received data, the data processor 208 may store some or all of received data, processed data and/or intermediate data in memory 206. The memory 206 may include RAM, ROM, and/or non-volatile memory.

Upon or during the processing the data, the data processor 208 may write the processed data to the memory 206 and/or to an output buffer 210.

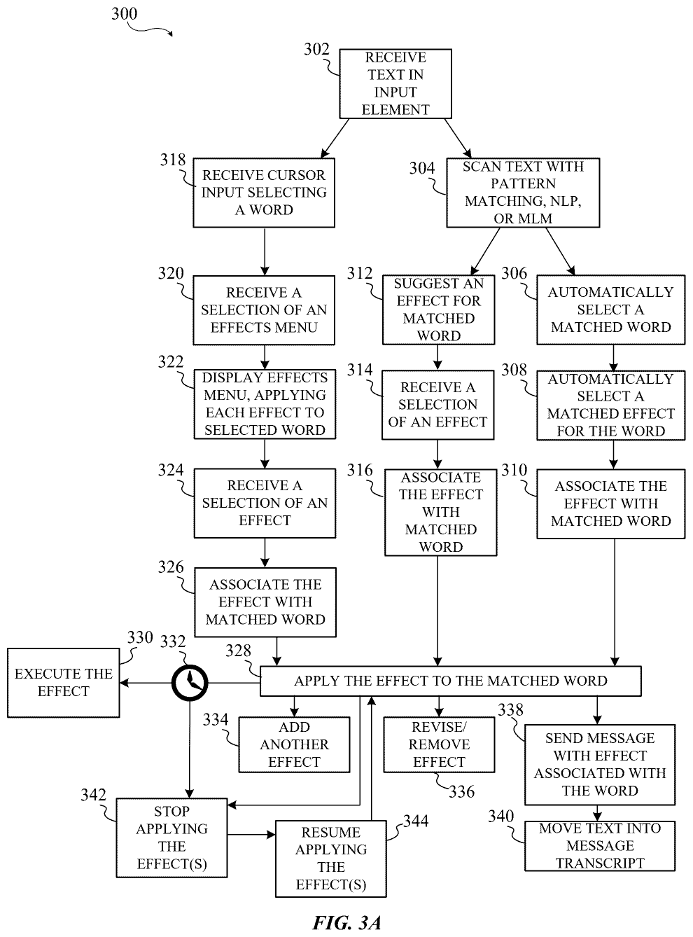

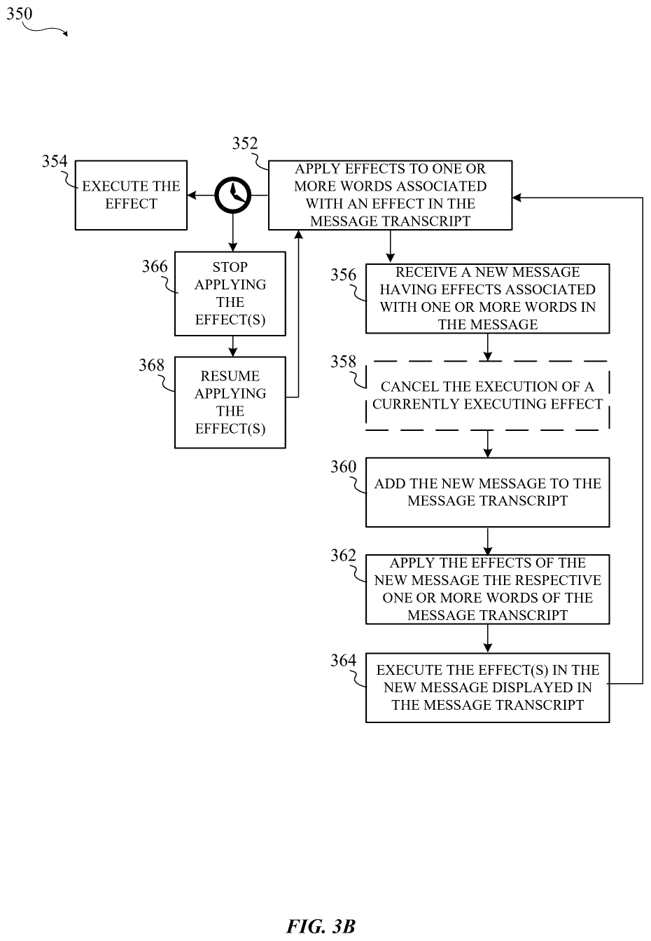

FIG. 3A illustrates a data flow diagram 300 for an example system for providing effects to one or more words of a message containing text and applying effects to a message and/or message transcript. One or more blocks (or operations) of the flow diagram of FIG. 3A may be performed by one or more other components and other suitable devices. Further for explanatory purposes, the blocks are described herein as occurring in serial, or linearly. However, multiple blocks of the process may occur in parallel. In addition, the blocks of the data flow need not be performed in the order shown and/or one or more blocks of the data flow need not be performed and/or can be replaced by other operations.

At block 302, a user may utilize their device (e.g., electronic device 110) to input text into an input element, for example of a messaging application. The text may be input utilizing any suitable mechanism, such as by typing the text by a software keyboard or a hardware keyboard or by pasting the text into the input element using a system pasting command.

At block 304, when text is input into the input element, the text may be scanned using pattern matching, NLP, or an MLM. The text may be scanned as it is typed into the input element or may be scanned after pasting.

In one or more implementations, the text may be scanned by a system process that implements a framework for providing the text animation effects to the messaging application and other applications. Alternatively, and/or in addition, the system process may provide an application programming interface (API) that may be utilized by the messaging application to scan the text and implement the text animation effects.

Pattern matching may be performed on the input text to determine whether a word that is being typed by the user matches a pattern for indicating an automatically selected word for a text effect. Pattern matching may also be used to provide predictive text elements and predictive effect suggestions. Pattern matching may also include, in addition to matching words which are indicative as indicating a mental state which may trigger the desire to put an effect on a word, forced pattern matching by the user, by utilizing designated characters which would automatically apply a certain effect to a word. For example, if a user offsets a word or phrase with brackets, asterisks, percent signs, dollar signs, at signs, hashtags, exclamation points, vertical bars or pipes, curly braces, etc., each of these can indicate a particular effect to be applied to the word which they encapsulate.

NLP can be used using a large language model to determine which words would be associated with which effects and a user's input text. MLM can be trained on initial test data and then further trained on the user's data as the user applies effects or removes effects. Thus the MLM can learn the preferences of the user with a relatively small model that can be stored and executed on the user's device. For example, when a user sends a message, that message can be provided to the MLM as training data, including whether an effect was applied or not applied by the user.

The pattern matching, NLP, or MLM process may provide suggested words and effects in the user's input as the user is typing, or as the user is otherwise inserting text into the input element. And when the pattern matching, NLP, or MLM processes provides a suggested word that meets a threshold indicating a confidence that the word should have an effect applied to it, then the flow can continue to block 306 to automatically apply an effect to the selected word. Otherwise, the flow can continue to block 312.

At block 306, if the pattern matching, NLP, or MLM text includes a word to which an effect is automatically applied, the word is automatically selected by the system for association with an effect. At block 308, an effect is matched to the word. The system may include several available effects, and one effect may be selected for the word. In some implementations, the effect may be selected from one or more effects based on the definitions of the pattern matching, the context of the word (e.g., as determined by NLP), or the usage preferences of the user. For example, effects that the user has previously applied more often to the matched word or to other words may be selected by the system.

At block 310, the selected effect can be associated with the matched word. In the association of the selected effect with the matched word, metadata for the text is updated to indicate that the matched word is associated with the word. The text effects may be specified in the text model via attributes specified over a range of text. In order to execute an effect an animator is obtained and it contains low-level animation primitive such as start, cancel, duration etc.

Returning back to block 304, the pattern matching, NLP, or MLM may identify a word as a candidate for an effect, but which does not automatically associate the word to an effect. The pattern matching, NLP, or MLM, may for example indicate a suggestion for an effect but may not reach a threshold which would cause an automatic application of the effect. In such situations, while the word is being typed or after the word is typed, at block 312 a suggestion for the effect can be provided on a suggestion element. The suggestion element may be in an area of the messaging application above the keyboard and below the message transcript, or some other suitable location. The suggestion element may present to the user a subselection of effects of the available effects. The subselection of effects can be selected based on the word, the frequency of prior use, predictions associated with the word, and so forth.

In some implementations, words for which suggestions are available may be tagged, such as by a different color or by a mark in the input element. For example, a word can be made red if an effect suggestion is available for the word. Selecting a tagged word can show the suggested effects in the suggestion element or may bring up an effects menu (described in further detail below).

At block 314, a selection of an effect is provided by the suggestion element, for example, when a user presses on the effect suggestion. At block 316, the selected effect can be associated with the matched word. In the association of the selected effect with the matched word, metadata for the text is updated to indicate that the matched word is associated with the selected effect.

Returning back to block 302, upon receiving text in the input element, in addition to or instead of moving to block 304, a cursor input may be received at block 318. The cursor input may indicate a word selected for applying an effect or for editing an applied effect.

When the location of the cursor is immediately before a word, the following word may be selected as the word relating to the effect. When the location of the cursor is immediately after a word, the preceding word may be selected as the word relating to the effect. When the location of the cursor is contained within the word, between the first letter and the last letter, then the word on which the cursor is contained may be selected as the word relating to the effect. In some implementations, a user may long press a word and the entire word would become highlighted, and the highlighted word can be considered the selected word. The user's system may also allow a user to select a word using a select command and moving a front bar and rear bar to encapsulate a selected word. In such cases the encapsulated word can be considered in the selected word relating to the effect.

At block 320, an input can be received which indicates the selection of an effects menu. The input, for example, may correspond to a software button located near the input element, such as another soft key of a keyboard input.

At block 322, an effects menu can be displayed. The effects menu can include a display of each available effect executed on the selected word (the word associated with the cursor input), in some implementations. The display of each available effect may include displaying the selected word in a grid pattern such that it is repeated a number of times corresponding to a number of available effects. For example, the selected word could be repeated nine times, arranged in a three by three grid, corresponding to nine available effects. In other implementations, the display of each available effect may include displaying each effect executed on a word corresponding to a familiar name for the effect. For example, if the effect is named “stretch,” then the word “stretch” can appear, and the effect corresponding to the stretch effect can be executed on the word “stretch.”

At block 322, a selection of an effect may be received based on a selection of an effect in the effects menu.

At block 324, the selected effect can be associated with the selected word. In the association of the selected effect with the selected word, metadata for the text is updated to indicate that the selected word is associated with the selected effect.

Block 328 may proceed from block 310, 316, or 326, and at block 328 the effect associated with each of the words in the text is applied to the word. Applying the effect associated with a word means that a display of the word is animated by executing 330 one or more effects on that word and that the display of the word may be animated again by executing 330 again one more effects to that word after a period of time 332. Thus, applying the effect may indicate that the associated effect is executed on the word. The effect may be executed on the word periodically.

At block 334, another effect may be added to the input text in the input element, for example, by returning to block 318 after a cursor is used to select another word. At block 336, an effect may be revised or removed. In some implementations, a word that has an effect associated with the word may be selected, such as described with respect to block 318, and an effects menu can be selected, such as described with respect to block 320, and an effects menu displayed such as described with respect to block 322. In some instances, when an effect is revised, another effect may be selected at block 324. In other instances, when and effect is removed, an option may be selected from the effects menu or another suitable menu to remove the effect associated with the selected word.

At block 338, in implementations where the input element corresponds to an input element of a messaging application, an indication can be received to send a message corresponding to the input element to another device, such as the electronic device 110, 115, or 120, by way of a server, such as the server 130. Upon receiving the indication to send the message, a send process may be executed and, at block 340, the text from the input element can be moved to a message transcript of the application that displays messages to and/or from a contact or group. Upon transferring the text from the input element to the message transcript (e.g., by sending the message to the contact or group), the text in the input element is added to the message transcript and any effects applied to the text in the input element may also be applied to the text in the message transcript after moving the text from the input element to the message transcript. In one or more implementations, when a word in the input element is in the middle of an animation effect (i.e., the effect is being executed on the word) when the text is moved from the input element to the message transcript, the effects being executed on a word in the input element may be paused, the state of the execution of the effect preserved, the text moved to the message transcript, and the execution of the effect resumed. In such instances, for example, the effect may preserve its state during moving the text from the input element to the message transcript. Thus, it should be understood that upon moving the text from the input element to the message transcript, the animation can be controlled by the flow discussed below with respect to block 352 of FIG. 3B.

At block 342, the effects that are applied to the word, to the input element, and/or to the message transcript may be stopped. In some implementations, the execution of the effects may be stopped by navigation away from the application, by selection of a stop execution or stop animation button in the interface, or by an elapse of time 332. For example, if the execution of all the effects in the message transcript and/or the input element has been repeated a few times, the period of time between executions can be lengthened and eventually execution can be halted by timing out.

At block 344, the applying the effect can be resumed. A soft button can be selected, for example, at the interface. The button can reenable the animations such that the effects associated with the words of the input element and/or the message transcript are applied, such as described with respect to block 328. In one or more implementations, applying the effect can be resumed by opening a message transcript that was previously closed. For example, a draft message may be entered into the input element with the application of one or more effects applied to one or more words. If that message conversation was closed, the effects may be paused as at block 342, however, when that message conversation is opened and when the draft message is restored to the input element, applying the effect can be resumed.

FIG. 3B illustrates a data flow diagram 350 for an example system for associating a message that has been sent or received with a message transcript, so that when the sent or received messages contain text having effects associated with one or more words of the text, the effects can be applied to the sent or received message and/or message transcript based on the associated effects. One or more blocks (or operations) of the flow diagram of FIG. 3B may be performed by one or more other components and other suitable devices. Further for explanatory purposes, the blocks are described herein as occurring in serial, or linearly. However, multiple blocks of the process may occur in parallel. In addition, the blocks of the data flow need not be performed in the order shown and/or one or more blocks of the data flow need not be performed and/or can be replaced by other operations.

At block 352, in the display of a message transcript, when one or more words in the message transcript are associated with an effect, such effects are respectively applied to the one or more words associated with an effect. Each of the words having an effect associated therewith, for example, may have been previously sent by a messaging application or received by the messaging application in a text message and added to the message transcript for display, either for the sender (for messages sent) or for the recipient (for messages received).

Applying the effects may be performed by utilizing the techniques described above with respect to block 328. In particular, at block 354, the effect corresponding to each word to which the effect is associated is executed. That is, when the effect is a dynamic effect, the word is animated according to the effect so that the display of the word is altered according to the effect. When the effect is a static effect, the effect is executed on the word so that the visual appearance is visually changed according to the static effect. In some implementations, both a static effect and dynamic effect can be applied. When the effect is a dynamic effect the execution (i.e., animation) of the effect can be performed periodically.

At block 356, a new message is received to be added to the message transcript (either a sent or received message) which has one or more effects associated with one or more words in the message. The message can include metadata specifying which effect is associated with which word.

At block 358, if a dynamic effect is currently being executed, then the execution of the effect can be cancelled. The cancellation can utilize spring physics to cancel the animation gracefully. For example, the glyphs corresponding to the word during an animation may be displaced from their normal positions. Physic spring operators can be attached to each of the letters to spring them back into their normal positions, e.g., from a first position corresponding to a partial execution of an effect to a second position corresponding to their normal positions. The spring physics can cause a displaced glyph to spring back along a vector toward the normal positions. When the glyph reaches the normal position, the glyph can extend slightly past the normal position, until a counteracting spring force is further applied to reverse the direction and bring the glyph back to its normal position.

At block 360, the new message can be added to the message transcript. The currently displayed transcript can be scrolled (up or down) to accommodate displaying the new message.

At block 362, recall that the message to be added to the message transcript has one or more effects associated with one or more words in the message to be added. Each effect can be applied to each respective word of the new message. Here, each effect can be applied to each word in the order in which the new message is received or presented in the message transcript. At block 364, when applying each of the effects to the new message, each of the effects can be executed in the new message displayed in the message transcript, for example, prior to executing effects and other portions of the message transcript. In other words, when the new message is added to the bottom of a message transcript, the dynamic effects of the new message may be executed on each effect in the new message after adding the new message to the message transcript and prior to executing effects on older messages in the message transcript.

After the new message is added to the message transcript, the flow can continue back to block 352 and any effects that are elsewhere displayed in the message transcript may be executed. As noted above, once all the effects are executed, a period of time may elapse prior to executing the effects again. And that period of time can be increasingly lengthened until at block 366 the effects are no longer applied. That is, the effects are not executed. Flow may also extend to block 366 when a user provides an input indicating to stop applying the effects. However, at block 368, an input may be received to resume applying the effects to the message transcript. In one or more implementations, applying the effect can be resumed by opening a message transcript that was previously closed. For example, effects applied to a displayed message transcript may be resumed when the message transcript is opened.

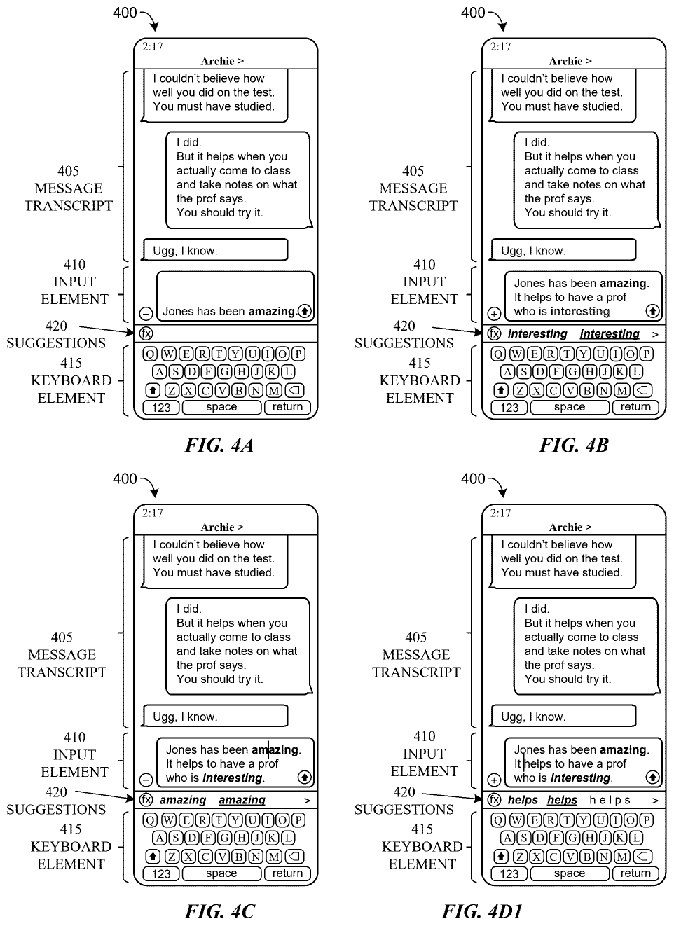

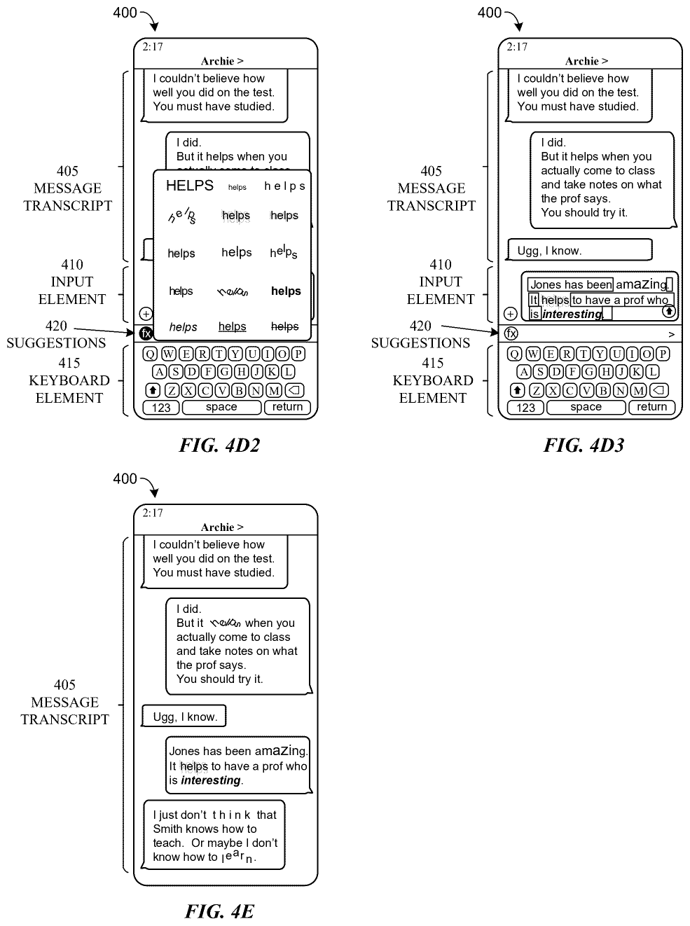

FIGS. 4A, 4B, 4C, 4D1, 4D2, 4D3, and 4E illustrate example interfaces which demonstrate a visual representation of the flow discussed above with respect to the data flow diagram 300 of FIG. 3A and/or data flow diagram 350 of FIG. 3B, in accordance with some embodiments. FIGS. 4A, 4B, 4C, 4D1, 4D2, 4D3, and 4E each illustrates an interface 400 of a messaging application, in accordance with some embodiments. It is appreciated that the drawings of FIGS. 4A, 4B, 4C, 4D1, 4D2, 4D3, and 4E need not include all the features illustrated and discussed below and may include other features and elements which are not provided for the sake of simplicity.

Each of the FIGS. 4A, 4B, 4C, 4D1, 4D2, 4D3, and 4E include various elements of the interface 400, including a message transcript 405 for messages which can hold therein a transcript of a conversation with a contact or group. An input element 410 may be provided where users can provide text or other items which are to be sent in the messaging application. A keyboard element 415 may be provided which corresponds to a software keyboard for providing text input to the input element 410. An effects suggestions element 420 may by an where suggested effects are displayed, for example, while a user types.

FIG. 4A illustrates that a message has been input into the input element as part of a conversation. In FIG. 4A, the bolded word “amazing” demonstrates that some words may automatically have effects applied to them through pattern matching, LLM, or MLM, as discussed above. Although the word amazing is presented in bold as illustrated in FIG. 4A, it should be understood that any effect may be utilized with the word amazing, including static effects or other dynamic effects. When a word has been typed which may be recognized as being one which has an effect applied to it, the corresponding effect (e.g., resulting from block 308) can immediately be associated with the word (e.g., as described with respect to block 310) in the input element, and the effect may be executed, such as described above with respect to block 328.

FIG. 4B Illustrates that a message has been input into the input element as part of a conversation. In FIG. 4B, the word bolded word “interesting” is displayed in red as a mark that an effect suggestion is available for the word. As the user is typing the word interesting, predictive text can be supplied which predicts that the user is trying to type the word interesting. At the same time, an effects suggestions element 420 can display suggested effects which can be applied to the word. The system, in other words, can predict that the user may want to apply an effect to the word “interesting” and, as such, may mark the word in some manner, such as by changing an appearance of the word, such as making the word a particular color, such as red. The user may select one of the presented effects suggestions or may scroll through additional suggestions by selecting, for example, a control element for scrolling sideways. The effects which are chosen for selection may be effects which have been selected for that word or for a similar word, effects which have been used by the user before, or effects which have been associated through other contextual means. The effects selected may be done so utilizing a classification model, for example.

FIG. 4C illustrates that a message has been input into the input element as part of a conversation. The word “amazing” has had an effect applied as has the word “interesting.” In FIG. 4B, a cursor is shown in the middle of the word “amazing.” When the system determines the position of the cursor is in a word, the system may highlight, for that word, suggested effects based on the word selected.

FIG. 4D1 illustrates a first panel in a series of panels of an example interface 400, such as described. In FIG. 4D1, a cursor control is provided at the beginning of the word “helps.” The position of the cursor control being immediately before the word “helps,” establishes that the word helps is selected. A position of the cursor control being immediately after the word “helps” would establish that the word “helps” is selected. A position of the cursor control being somewhere within the word helps would establish that the word helps us selected. Upon selecting the word, suggested effects can be displayed in the effects suggestion element 420.

In accordance with some implementations, an effects button (reference item “FX”) in FIG. 4D1. When an input is received which indicates that the effects button was selected, an effects menu may be provided. As shown in FIG. 4D2, the effects menu may include a preview animation sample of each of the effects that are available as applied to the selected word. In other implementations, the preview animation may be provided to an alternative word, such as a short word describing the animation effect. When one or more of the available effects are not animated effects, the word may be shown with the static effect applied.

In the example effects menu shown in FIG. 4D2, a number of effects are displayed. It should be understood that these effects as applied in the depiction of the available effects represent, for the dynamic effects, an intermediate state of an animated word. The actual effect is in motion for each of the dynamic effects. It should be understood also that the effects displayed and described herein, are merely examples and other effects may be provided. Starting with the top left illustrated effect, the effects can include making the text larger and/or all caps. This effect can appear animated by having the text appear normal, and when the effect is executed, it becomes large and all caps, and then returns back to normal. To the right, the effects can include making the text smaller. This effect can appear animated by having the text appear normal, and when the effect is executed, it becomes small, and then returns back to normal. To the right of that the effects can include spacing out the letters of the word. This effect can appear animated by having the text appear normal, and when the effect is executed, it becomes spaced out, and then returns back to normal.

In the next row, the first effect on the left, the effects can include an animation that makes the letters appear as if they are blowing up. This effect can appear animated by having the text appear normal, and when the effect is executed it moves in a pattern that looks as if the word is being destroyed from the middle of the word outward. When the animation is over, a blank space can have the word pop back to normal. To the right of that, the effects can include a jitter effect. This effect can appear animated by having the text appear normal, and when the effect is executed it moves in a shaking pattern that makes it look jittery, and then return back to normal. To the right of that, the effects can include a horizontal shake effect. This effect can appear animated by having the text shake back and forth horizontally, and then return back to normal.

In the next row, the first effect on the left, the effects can include a vertical shake. This effect can appear animated by having the text shake up and down vertically, and then return back to normal. To the right of that, the effects can include a ripple effect, where the font size is increased starting at the left portion of the word, making each glyph larger in succession, where the size returns to normal as the size increase continues to move toward the right. This effect can appear animated by having the text appear normal, and when the effect is executed, the first glyph or character of the word gets larger, and then the next glyph or character of the word appears to get larger, and then the next glyph or character of the word appears to get larger. When each subsequent glyph or character appears to get larger the previous glyph or character appears to get smaller, and back to a normal size. Thus, a large ripple effect is demonstrated. To the right of that, the effects can include a wave effect. This effect can appear animated by having the text rise up in a wave pattern, and then return back to normal.

Next row, the first effect on the left, the effects can include spacing the word letters or glyphs closer together. This effect can appear animated by having the text appear normal, and when the effect is executed, the letters become tightly spaced together in an animation, and then return back to normal. To the right of that, the effects can include making the letters fall over as if they are tired. This effect can appear animated by having the letters appear normal, and then when the effect is executed the letters appear to fall over randomly, and then return to normal. To the right of that the next effect can include a bold effect. This effect can appear animated by having the letters appear normal, and then when the effect is executed the letters become bold, and then return back to normal. This effect can also be static. If static, this effect can be combined with another effect.

Next row, the first effect on the left, the effects can include making the letters italicized. This effect can appear animated by having the letters appear normal, and then when the effect is executed the letters become italicized, and then return back to normal. This effect can also be static. If static, this effect can be combined with another effect. To the right of that, the next effect can include an underlying effect. This effect can appear animated by having the letters appear normal, and then when the effect is executed the letters become underline, and then return back to normal. This effect can also be static. If static, this effect can be combined with another effect. To the right of that, the next effect can include a strike through effect. This effect can appear animated by having the letters appear normal, and then when the effect is executed the letters become strikethrough, and then return back to normal. This effect can also be static. If static, this effect can be combined with another effect.

The available effects can be configured also, so that if they have an animation that is directional, for languages that read right to left instead of left to right, the animation associated with the effect can be performed in an opposite direction (e.g., right to left instead of left to right). Each effect has a unique set of defined parameters which specify the animation parameters for animation processing. For example, each effect has a length of time of execution, and each effect has a way to define how different letters or symbols are rotated, transformed, skewed, increased in size, or decreased in size and so forth in order to accomplish the application of effects.

FIG. 4D3 illustrates the insertion of the selected effect into the input element 410. FIG. 4D3 also illustrates that other portions of the text in the input element may be seen as being contained in static blocks. When an animation is executed, e.g., an effect is executed so that the display is altered, rather than animate the blocks on either side or up and down from the word that is being animated (or having an effect applied thereto), a compositor can move the words as blocks to accommodate the animation. Utilizing a compositor to move the blocks rather than animate them being moved, saves processing power and resources.

In FIG. 4E, the message transcript 405 is displayed. FIG. 4E illustrates that a received message is included into the message transcript 405. In this case, because the received message has at least one effect associated with a word of the received message, any execution of effects for the message transcript of older messages can be cancelled (e.g., block 366), and the newly added message to the message transcript maybe executed. After execution, the system can jump back up to the top of the message transcript and begin animating each of the messages in turn again. As noted above, a time lapse can occur between executing effects.

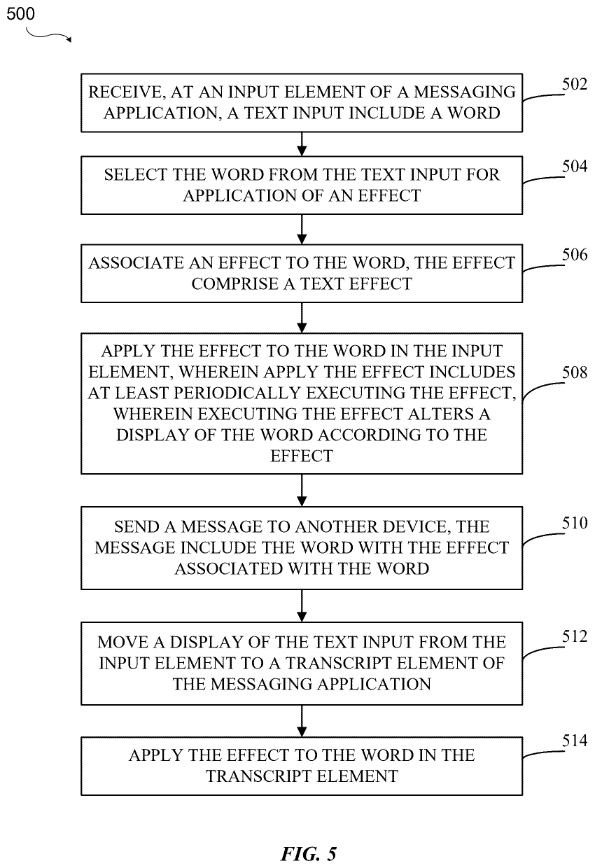

FIG. 5 illustrates a flow of an example process 500 for applying an effect to one or more words in an input element, in accordance with some embodiments. One or more blocks (or operations) of the process flow diagram of FIG. 5 may be performed by one or more other components and other suitable devices. Further for explanatory purposes, the blocks are described herein as occurring in serial, or linearly. However, multiple blocks of the process may occur in parallel. In addition, the blocks of the process need not be performed in the order shown and/or one or more blocks of the process need not be performed and/or can be replaced by other operations.

At block 502, the process 500 may include receiving, at an input element of a messaging application, a text input include a word. For example, a device, such as the electronic device 110, may receive text input via a user input element via a keyboard or a paste command, such as described above with respect to block 302.

At block 504, the process 500 may include selecting the word from the text input for application of an effect. For example, the device may select the word from the text input for application of an effect based on pattern matching, NLP, or MLM, as described above with respect to block 304 or by a cursor input as described with respect to block 318.

At block 506, the process 500 may include associating an effect to the word, the effect having a text effect. The associating the effect to the word may occur, for example, according to the circumstances described with respect to block 310, 316, and/or 326.

At block 508, the process 500 may include applying the effect to the word in the input element, where applying the effect includes executing the effect, where executing the effect alters a display of the word according to the effect. The effect may be applied periodically. Applying the effect for example, can be performed such as described above with respect to block 328 and/or 352.

At block 510, the process 500 may include send a message to another device, the message including the word with the effect associated with the word. While the effect is being executed in the input element, the association of the effect to the word can be sent to another device along with the text from the input element, such as described with respect to block 338.

At block 512, the process 500 may include moving a display of the text input from the input element to a transcript element of the messaging application. Although the text input may have effects currently animating, the text in the input element can be moved to the message transcript where the animation is resumed. Moving the text from the input element to the message transcript may be performed such as described with respect to block 340.

At block 514, the process 500 may include applying the effect to the word in the transcript element. As just noted, the effect may still be applied to the word after the message is sent and moved from the input element to the transcript element.

In one implementation, in response to receiving the text input including the word, the text input can be analyzed by a pattern matching engine or a machine learning model, wherein the word is selected from the text input for association of the effect to the word based on the analysis. The word can be displayed in an effects suggestion element of the messaging application while applying the effect to the word in the effects suggestion element, or the effect can be applied to the word in the input element. In some implementations, when the word is displayed in the effects suggestion element, the word is displayed in multiple instances of the word in the effects suggestion element while applying a unique effect to each instance of the word in the effect suggestion element.

In some implementations, the effect is a dynamic effect causing the word to be animated, a static effect altering a display characteristic of the word, or both a dynamic effect and a static effect. In some implementations an input is received indicating a selection of an effects menu. The word can be displayed in the effects menu, where the effects menu includes a demonstration of one or more available effects, the demonstration including each of the one or more available effects applied to the word in the effects menu. An input indicating a selection of a selected effect of the one or more available effects may be received, where the effect comprises the selected effect and associating the effect to the word is performed in response to receiving the input indicating the selection.

A cursor input can be received in the input element, the cursor input indicating a position of a cursor relative to the text input, where the word is selected from the text input for association of the effect based on the position of the cursor. The word following the cursor may be selected when the cursor is positioned immediately before the word, wherein the word preceding the cursor may be selected when the cursor is positioned immediately after the word, and wherein the word on either side of the cursor may be selected when the cursor is positioned between a first symbol of the word and a last symbol of the word.

In some implementations, the effect may include an animation sequence applied to the display of the word, where sending the message occurs during the animation sequence being applied to the display of the word, and pausing the animation sequence prior to moving the display of the text input from the input element to the transcript element; and resuming the animation sequence after moving the display of the text input to the transcript element.

In some implementations, the word is written in a language or font utilizing a connected script, and while executing the effect on the word, adjusting grapheme clusters corresponding to the word so that consecutive grapheme clusters stay connected. For example, some languages use non-Unicode characters and/or connected lines. Grapheme clusters can be used to represent such characters. In this context, a grapheme cluster is a collection of symbols or marks that together represent an individual character.

In some aspects, a request can be received to transmit the message container including the selected image. Responsive to receiving the request, the message container can be transmitted by the messaging application, the message container including the selected image in association with the URL to another device. Further responsive to receiving the request, a display of the message container in the input element can be moved to a message transcript element of the application.

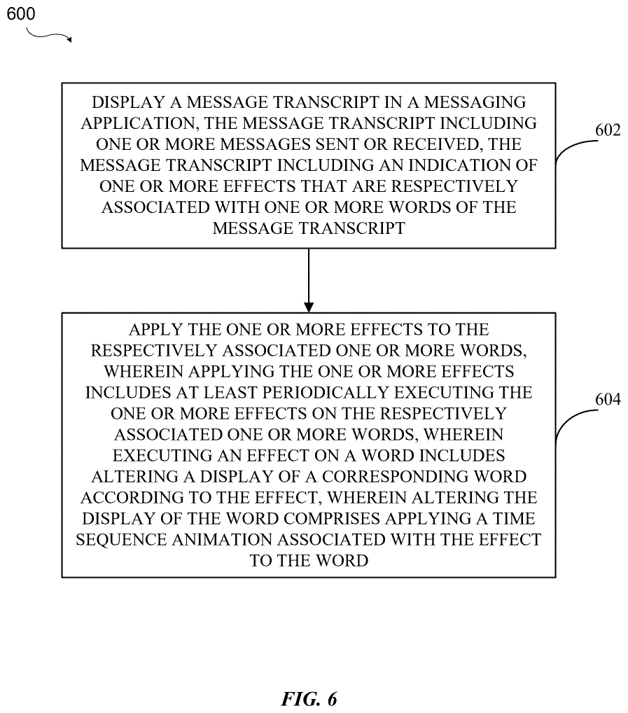

FIG. 6 illustrates a flow of an example process 600 for applying an effect to one or more words in an input element, in accordance with some embodiments. One or more blocks (or operations) of the process flow diagram of FIG. 6 may be performed by one or more other components and other suitable devices. Further for explanatory purposes, the blocks are described herein as occurring in serial, or linearly. However, multiple blocks of the process may occur in parallel. In addition, the blocks of the process need not be performed in the order shown and/or one or more blocks of the process need not be performed and/or can be replaced by other operations.

At block 602, the process 600 may include displaying a message transcript in a messaging application, the message transcript including one or more messages sent or received, the message transcript including an indication of one or more effects that are respectively associated with one or more words of the message transcript. The message transcript may be displayed in a manner such as described above with respect to block 340.

At block 604, the process 600 may include applying the one or more effects to the respectively associated one or more words, where applying the one or more effects includes executing the one or more effects on the respectively associated one or more words, where executing an effect on a word includes altering a display of a corresponding word according to the effect, where altering the display of the word comprises applying a time sequence animation associated with the effect to the word. The effect may be executed periodically. Applying the one or more effects may performed in a manner such as described with respect to block 328 and/or 352.

In one implementation, the process 600 can also include receiving a new message at the messaging application, the new message including a text portion and an indication of one or more new effects respectively associated with one or more new words of the text portion; cancelling a current execution of an effect in the message transcript. The new message may be added to the message transcript. Each of the one or more new effects may then be applied to the respectively associated one or more new words in the new message, for example, before applying effects on the older portion of the message transcript.

In some implementations, cancelling the current execution of the effect comprises applying spring physics to the current execution of the effect to bring the current execution of the effect from a first state to a second state, the first state being mid-execution of the effect, the second state being post execution of the effect.

In some implementations, executing the one or more effects is performed in succession in an order displayed in the message transcript. After executing a last effect in the message transcript, the executing the one or more effects may be performed again. Prior to performing the executing again, the process 600 can include waiting a predetermined time period before executing the one or more effects is performed again. In some aspects, the predetermined time period may be extended each time the one or more effects is performed again.

In some implementations, the messages of the message transcripts may be displayed in message groups, for example, when one message is displayed as a reply to another message, or when a set of messages interrelates by time, whereas another set of messages interrelates by a different time. In such situations, after executing a first effect of the one or more effects corresponding to a first message group, waiting a predetermined time before executing a next effect of the one or more effects corresponding to a second message group following the first message group. In other words, while animation of one effect to the next effect may have overlap so that for a small amount of time two animations are executing, a predetermined delay may be used between message groups.

In some implementations, when executing a first effect on a first word in the message transcript, the first word written in a language or font utilizing a connected script, the executing the first effect may be performed so that the connected script remains connected during the execution of the first effect on the first word.

In some implementations, the executing the effects is performed by executing a first effect on a first word in the message transcript, and before completing the execution of the first effect on the first word, beginning execution of a second effect on a second word in the message transcript. The second effect may be begun when the execution of the first effect reaches a trigger point during the execution of the first effect. The trigger point may be related to the length of the word, the effect being applied to the word, or a combination thereof. For example, the trigger point may correspond to a point when the corresponding effect is 85% complete, though another percentage can be used.

The process 600 may include receiving, while executing a first effect of the one or more effects, an input indicating an instruction to scroll the message transcript; pausing the execution of the first effect; preserving a state of the execution of the first effect; scrolling the message transcript; and when a word corresponding to the paused execution of the first effect remains displayed after scrolling, resuming the execution of the first effect based on the preserved state of the execution of the first effect; and when the word corresponding to the paused execution of the first effect is scrolled out of display view, executing a second effect of the one or more effects. Scrolling may instead be performed while animations are ongoing.

In one or more implementations, a word may be represented by a series of grapheme clusters, for example, when a language may be used that utilizes non-Unicode characters or components or utilizes connected script components. In such instances, the animation of a word may include animating the grapheme clusters, where each of the one or more effects corresponds to a time sequenced transform per grapheme cluster of a corresponding word, and where each of the time sequenced transforms comprises a combination of translation, scale, rotation, and stretch for each grapheme cluster. In one or more implementations, a word may be represented by a series of glyphs, where each of the glyphs comprises a combination of subcomponents. In such implementations, the animation may correspond to a separate alteration of the display of each subcomponent of the combination of subcomponents during executing the effect. As noted above, animating a word can include using a compositor to move around adjacent static words to make room for an animated word.

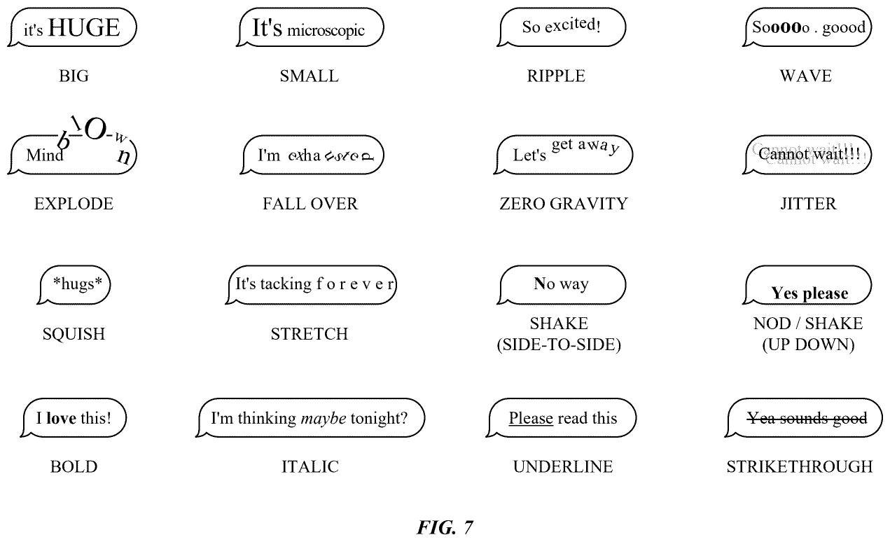

FIG. 7 provides an illustration of a various number of effects which may be provided to a user for selection for selecting and sending and represents the various effects that may be implemented on a received message. More or fewer effects may be defined. Additional effects may include effects related to the display of the font either in a dynamic effect or in a static effect. Effects may include, for example, effects related to the color of the font. For example, the color of a font may be a shimmering color or a rainbow color, and so forth.

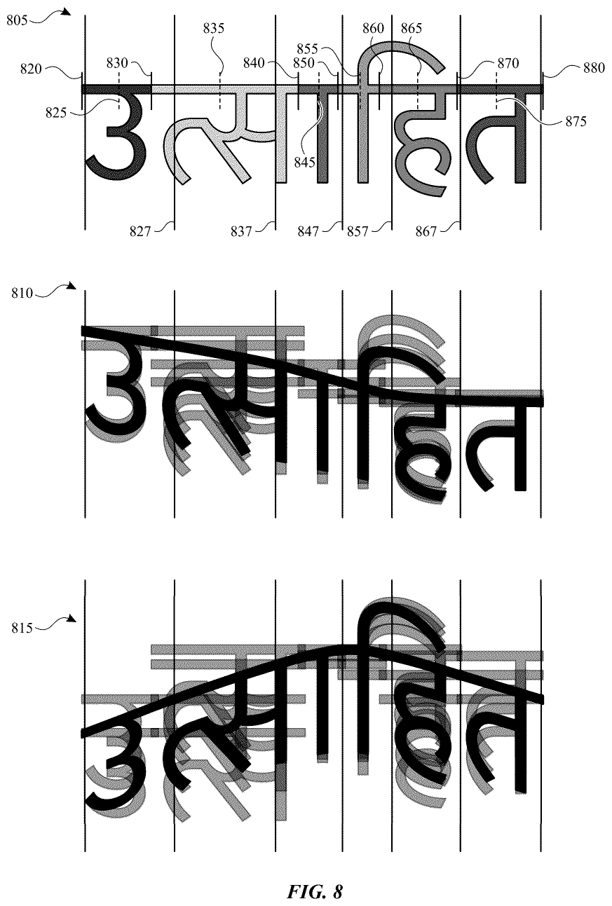

FIG. 8 provides an illustration of a connected script undergoing a wave effect and the application of interpolated transforms. Such transforms may also be used on words which are not connected. Each glyph gets a drawing state which can product an affine transform. Adjacent glyphs in the same connected scripts (like Arabic, Hindi) smoothly interpolates. This is done by creating state markers where each marker has an interpolated state. Any given point in a glyph uses a t value and 4 of these markers for cubic bezier interpolation of the state. Once the states are interpolated using the bezier weight the transform can be derived. The illustration 805, shows a connected script. With subcomponent animations, glyphs can be split into subcomponents and each subcomponent can be animated separately.

The illustration 810 shows the view of 805 at a time t+1 during an animation of the connected script. The illustration 815 shows the view of 805 at a time t+2 during an animation of the connected script. The animation in this case is a sine wave animation, such as used in a wave effect or ripple effect. The anchor points for the connected script may be chosen using any suitable techniques. In the illustrated animation of FIG. 8, the anchor points for the connected script are selected by taking the midpoint of a midpoint and selecting that as an anchor point.

The first anchor line 820 is determined to be the beginning of the script including six glyphs. The last anchor line 880 is determined to be the end of the script. The line 830 represents a demarcation between the first glyph and the second glyph. The line 840 represents a demarcation between the second glyph and the third glyph. The line 850 represents a demarcation between the third glyph and the fourth glyph. The line 860 represents a demarcation between the fourth glyph and the fifth glyph. The line 870 represents a demarcation between the fifth glyph and the sixth glyph. The midpoint line 825 is the midpoint between the line 820 and the line 830. The midpoint line 835 is the midpoint between the line 830 and the line 840. The midpoint line 845 is the midpoint between the line 840 and the line 850. The midpoint line 855 is the midpoint between the line 850 and the line 860. The midpoint line 865 is the midpoint between the line 860 and the line 870. The midpoint line 875 is the midpoint between the line 870 and the line 880. The anchor lines are selected to be the midpoints between the midpoints. Thus, the second anchor line 827 is the midpoint between the midpoint lines 825 and 835, the third anchor line 837 is the midpoint between the midpoint lines 835 and 845, the fourth anchor line 847 is the midpoint between the midpoint lines 845 and 855, the fifth anchor line 857 is the midpoint between the midpoint lines 855 and 865, and the sixth anchor line 867 is the midpoint between the midpoint lines 865 and 875.

The illustration 810 shows a position of the script when the y-offset on the first anchor line 820 and second anchor line 827 are positive, the drawing of the script between those points is an interpolation.

FIG. 9 illustrates an interpolation 900, in accordance with some implementations. It should be understood that this interpolation is for a specific effect and other interpolations may be used for other effects. Further, the interpolation is for displacement along the y-axis. Another interpolation like unto this one may be used for interpolation along the x-axis, interpolation for rotation, and interpolation for size.

In an implementation, first a font weight and font size are determined for an animation effect and an interpolation is developed for the font weight and font size. Then, an interpolation for displacement, rotation, and size can be used to adjust the values determined for the interpolation according to the font weight and font size.

The interpolation 900 includes anchor lines 910, 920, 930, 940, and 950, which may be determined for a script, in a manner such as described above with respect to FIG. 8. Each of the anchor lines includes a y-axis value which is determined by the definition of the animation effect. The vertical dashed lines 912, 916, 922, and so forth are tangent lines for interpolated states between the anchor lines. Each of the y-axis values on the tangent lines, such as the value 913, 917, 923, and so forth may be determined by a calculation between corresponding tangent lines, except for the first y-axis value and the last y-axis value. The first y-axis value 913 on the tangent line 912, can be determined by being the point along a line that intersects the first y-axis value on the anchor line 910 and the anchor line 920. The second y-axis value 917 on the tangent line 916 can be determined by being the point along a line that intersects the y-axis value on second anchor line 920 that also intersects the next y-axis value 923 on the next tangent line 922.

After determining the y-axis values for the tangent lines, cubic bezier interpolation or another fitting algorithm can be used to define the intermediate states for the animation. It should be appreciated that the interpolation 900 is merely an example. In general, a scripted language can remain connected using interpolated states utilizing anchoring points. The anchoring points need not be at the demarcation of glyphs, however, and may be selected based on other criteria, such as described herein as a midpoint of midpoints.

As described herein the subject technology provides the ability for intelligent input. Suggestions can be provided based on patterns as well as autocompletion based on patterns. Automatic playback or execution of effects is performed when entering a transcript. It can be performed first on new messages and then begun again at the top of visible messages. Each animation has unique duration based on content, timing functions etc. Each animation type may have a unique trigger point when it's okay for the next animation to trigger. Delays between each animation in message can be used; unique delays between messages and message groups can also be used. Delays after finishing last (bottom) visible effect can be used before starting over at top visible effect. The system and processes also handling new effects sent/received in the middle of executing effects. Scrolling may be performed while performing the executing of effects.

Efficient rendering and playback can be achieved. Utilizing segmentation, displacement, interpolating paths, and so forth, offload to GPU for rasterization. Segmentation of content into static and dynamic areas means only dynamic areas are re-drawn. Static areas may be displaced (shifted horizontally or vertically) but such displacement does not require re-rendering but rather just composition.

Extraction and analysis of paths may be performed up-front (at start of animation). In some instances, a pre-compute of next frame can be performed on a different thread.

Transforms may be applied per grapheme cluster such that each effect in general provides a unique transform per grapheme cluster. These transforms may involve translation, scale, and rotation. The metrics (width, height) may also be modified per grapheme cluster.

Static effects can be used to provide and apply a drawing only filter to a corresponding word or set of words. These can be used to add various colorful effects by themselves or on top of transforming (dynamic) effects.

As described above, one aspect of the present technology is the gathering and use of data available from specific and legitimate sources for providing images for selection by a user obtained via electronic devices. The present disclosure contemplates that in some instances, this gathered data may include personal information data that uniquely identifies or can be used to identify a specific person. Such personal information data can include voice data, demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used for providing user selected, user provided, and/or user controlled images to another based on inputs from the user. Accordingly, use of such personal information data may facilitate transactions (e.g., on-line transactions).

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of operating an electronic device to provide user supplied images or annotations, the present technology can be configured to allow users to select to “opt in” or “opt out” of participation in the collection of personal information data during access to user-controlled photo libraries or inputs. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

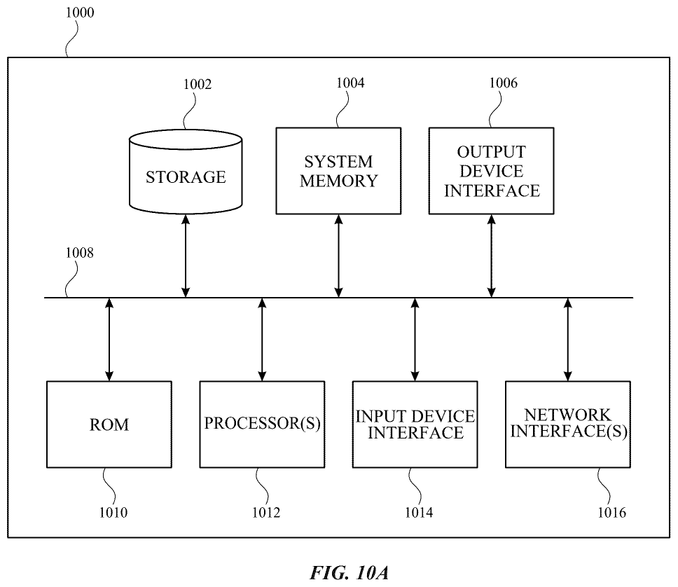

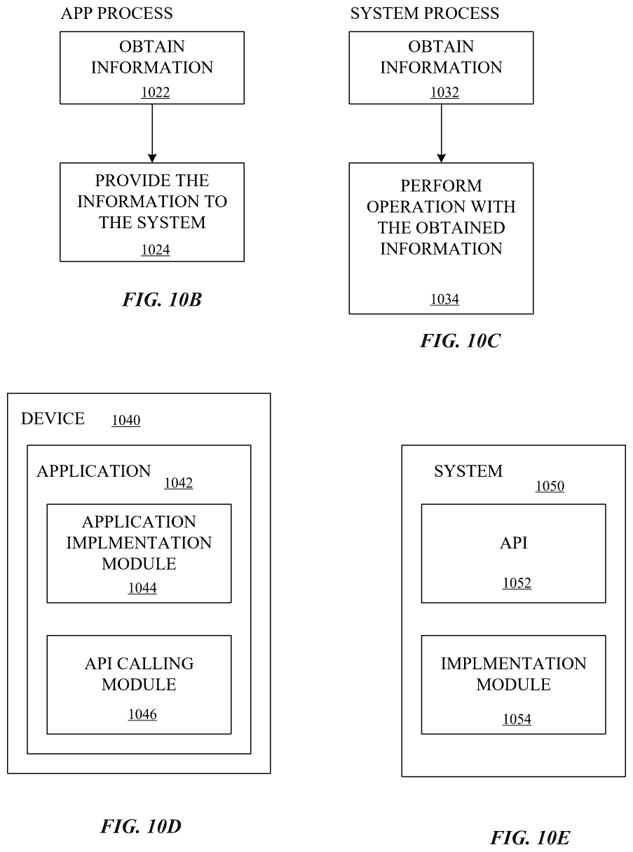

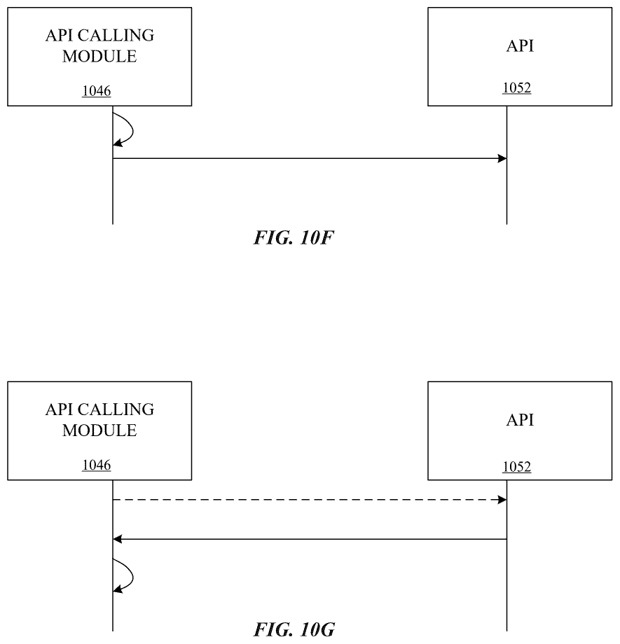

FIG. 10 illustrates an electronic system 1000 with which one or more implementations of the subject technology may be implemented. The electronic system 1000 can be, and/or can be a part of, one or more of the electronic devices 110, 115, and/or 120. The electronic system 1000 may include various types of computer readable media and interfaces for various other types of computer readable media. The electronic system 1000 includes a bus 1008, one or more processing unit(s) 1012, a system memory 1004 (and/or buffer), a ROM 1010, a permanent storage device 1002, an input device interface 1014, an output device interface 1006, and one or more network interfaces 1016, or subsets and variations thereof.

The bus 1008 collectively represents all system, peripheral, and chipset buses that communicatively connect the numerous internal devices of the electronic system 1000. In one or more implementations, the bus 1008 communicatively connects the one or more processing unit(s) 1012 with the ROM 1010, the system memory 1004, and the permanent storage device 1002. From these various memory units, the one or more processing unit(s) 1012 retrieves instructions to execute and data to process in order to execute the processes of the subject disclosure. The one or more processing unit(s) 1012 can be a single processor or a multi-core processor in different implementations.

The ROM 1010 stores static data and instructions that are needed by the one or more processing unit(s) 1012 and other modules of the electronic system 1000. The permanent storage device 1002, on the other hand, may be a read-and-write memory device. The permanent storage device 1002 may be a non-volatile memory unit that stores instructions and data even when the electronic system 1000 is off. In one or more implementations, a mass-storage device (such as a magnetic or optical disk and its corresponding disk drive) may be used as the permanent storage device 1002.

In one or more implementations, a removable storage device (such as a flash drive) may be used as the permanent storage device 1002. Like the permanent storage device 1002, the system memory 1004 may be a read-and-write memory device. However, unlike the permanent storage device 1002, the system memory 1004 may be a volatile read-and-write memory, such as random access memory. The system memory 1004 may store any of the instructions and data that one or more processing unit(s) 1012 may need at runtime. In one or more implementations, the processes of the subject disclosure are stored in the system memory 1004, the permanent storage device 1002, and/or the ROM 1010. From these various memory units, the one or more processing unit(s) 1012 retrieves instructions to execute and data to process in order to execute the processes of one or more implementations.

The bus 1008 also connects to the input and output device interfaces 1014 and 1006. The input device interface 1014 enables a user to communicate information and select commands to the electronic system 1000. Input devices that may be used with the input device interface 1014 may include, for example, alphanumeric keyboards and pointing devices (also called “cursor control devices”). The output device interface 1006 may enable, for example, the display of images generated by electronic system 1000. Output devices that may be used with the output device interface 1006 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 10, the bus 1008 also couples the electronic system 1000 to one or more networks and/or to one or more network nodes, through the one or more network interface(s) 1016. In this manner, the electronic system 1000 can be a part of a network of computers (such as a LAN, a wide area network (“WAN”), or an Intranet, or a network of networks, such as the Internet. Any or all components of the electronic system 1000 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FcTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Implementations within the scope of the present disclosure include a computer-readable storage medium that encodes instructions organized as an application (e.g., application 1022) that, when executed by one or more processing units, control an electronic device (e.g., device 1020) to perform the method of FIG. 10A, the method of FIG. 10B, and/or one or more other processes and/or methods described herein.

It should be recognized that application 1022 (shown in FIG. 10C) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 1022 is an application that is pre-installed on device 1020 at purchase (e.g., a first party application). In other embodiments, application 1022 is an application that is provided to device 1020 via an operating system update file (e.g., a first party application or a second party application). In some embodiments, application 1022 is an application that is provided via an application store. In some embodiments, the application store can be an application store that is pre-installed on device 1020 at purchase (e.g., a first party application store). In some embodiments, the application store is a third-party application store (e.g., an application store that is provided by another application store, downloaded via a network, and/or read from a storage device).

Referring to FIG. 10A and FIG. 10E, application 1022 obtains information (e.g., 1002). In some embodiments, at 1002, information is obtained from at least one hardware component of the device 1020. In some embodiments, at 1002, information is obtained from at least one software module (e.g., set of instructions) of the device 1020. In some embodiments, at 1002, information is obtained from at least one hardware component external to the device 1020 (e.g., a peripheral device, an accessory device, and/or a server). In some embodiments, the information obtained at 1002 includes positional information, time information, notification information, user information, environment information, electronic device state information, weather information, media information, historical information, event information, hardware information, and/or motion information. In some embodiments, in response to and/or after obtaining the information at 1002, application 1022 provides the information to a system (e.g., 1004).

In some embodiments, the system (e.g., 1030 shown in FIG. 10D) is an operating system hosted on the device 1020. In some embodiments, the system (e.g., 1030 shown in FIG. 10D) is an external device (e.g., a server, a peripheral device, an accessory, and/or a personal computing device) that includes an operating system.

Referring to FIG. 10B and FIG. 10F, application 1022 obtains information (e.g., 1012). In some embodiments, the information obtained at 1012 includes positional information, time information, notification information, user information, environment information electronic device state information, weather information, media information, historical information, event information, hardware information and/or motion information. In response to and/or after obtaining the information at 1012, application 1022 performs an operation with the information (e.g., 1014). In some embodiments, the operation performed at 1014 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 1030 based on the information.

In some embodiments, one or more steps of the method of FIG. 10A and/or the method of FIG. 10B is performed in response to a trigger. In some embodiments, the trigger includes detection of an event, a notification received from system 1030, a user input, and/or a response to a call to an API provided by system 1030.

In some embodiments, the instructions of application 1022, when executed, control device 1020 to perform the method of FIG. 10A and/or the method of FIG. 10B by calling an application programming interface (API) (e.g., API 1032) provided by system 1030. In some embodiments, application 1022 performs at least a portion of the method of FIG. 10A and/or the method of FIG. 10B without calling API 1032.

In some embodiments, one or more steps of the method of FIG. 10A and/or the method of FIG. 10B includes calling an API (e.g., API 1032) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 10C, device 1020 is illustrated. In some embodiments, device 1020 is a personal computing device, a smart phone, a smart watch, a fitness tracker, a head mounted display (HMD) device, a media device, a communal device, a speaker, a television, and/or a tablet. Device 1020 includes application 1022 and an operating system (not shown) (e.g., system 1030 shown in FIG. 10D). Application 1022 includes application implementation instructions 1024 and API calling instructions 1026. System 1030 includes API 1032 and implementation instructions 1034. It should be recognized that device 1020, application 1022, and/or system 1030 can include more, fewer, and/or different components than illustrated in FIGS. 10C and 10D.

In some embodiments, application implementation instructions 1024 is a software module that includes a set of one or more computer-readable instructions. In some embodiments, the set of one or more instructions of instructions 1024 correspond to one or more operations performed by application 1022. For example, when application 1022 is a messaging application, application implementation instructions 1024 can include operations to receive and send messages. In some embodiments, application implementation instructions 1024 communicates with API calling instructions to communicate with system 1030 via API 1032 (shown in FIG. 10D).

In some embodiments, API-calling instructions 1026 is a software module that includes a set of one or more computer-executable instructions.

In some embodiments, implementation instructions 1034 is a software module that includes a set of one or more computer-executable instructions.

In some embodiments, API 1032 is a software module that includes a set of one or more computer-executable instructions. In some embodiments, API 1032 provides an interface that allows a different set of instructions (e.g., API calling instructions 1026) to access and/or use one or more functions, methods, procedures, data structures, classes, and/or other services provided by implementation instructions 1034 of system 1030. For example, API-calling instructions 1026 can access a feature of implementation instructions 1034 through one or more API calls or invocations (e.g., embodied by a function or a method call) exposed by API 1032 and can pass data and/or control information using one or more parameters via the API calls or invocations. In some embodiments, API 1032 allows application 1022 to use a service provided by a Software Development Kit (SDK) library. In some embodiments, application 1022 incorporates a call to a function or method provided by the SDK library and provided by API 1032 or uses data types or objects defined in the SDK library and provided by API 1032. In some embodiments, API-calling instructions 1026 makes an API call via API 1032 to access and use a feature of implementation instructions 1034 that is specified by API 1032. In such embodiments, implementation instructions 1034 can return a value via API 1032 to API-calling instructions 1026 in response to the API call. The value can report to application 1022 the capabilities or state of a hardware component of device 1020, including those related to aspects such as input capabilities and state, output capabilities and state, processing capability, power state, storage capacity and state, and/or communications capability. In some embodiments, API 1032 is implemented in part by firmware, microcode, or other low level logic that executes in part on the hardware component.

In some embodiments, API 1032 allows a developer of API-calling instructions 1026 (which can be a third-party developer) to leverage a feature provided by implementation instructions 1034. In such embodiments, there can be one or more set of API-calling instructions (e.g., including API-calling instructions 1026) that communicate with implementation instructions 1034. In some embodiments, API 1032 allows multiple sets of API-calling instructions written in different programming languages to communicate with implementation instructions 1034 (e.g., API 1032 can include features for translating calls and returns between implementation instructions 1034 and API-calling instructions 1026) while API 1032 is implemented in terms of a specific programming language. In some embodiments, API-calling instructions 1026 calls APIs from different providers such as a set of APIs from an OS provider, another set of APIs from a plug-in provider, and/or another set of APIs from another provider (e.g., the provider of a software library) or creator of the another set of APIs.

Examples of API 1032 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 1020. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation instructions 1034 is a system (e.g., operating system, server system) software module (e.g., a collection of computer-readable instructions) that is constructed to perform an operation in response to receiving an API call via API 1032. In some embodiments, implementation instructions 1034 is constructed to provide an API response (via API 1032) as a result of processing an API call. By way of example, implementation instructions 1034 and API-calling instructions 1026 can each be any one of an operating system, a library, a device driver, an API, an application program, or other module. It should be understood that implementation instructions 1034 and API-calling instructions 1026 can be the same or different type of software module from each other. In some embodiments, implementation instructions 1034 is embodied at least in part in firmware, microcode, or other hardware logic.

In some embodiments, implementation instructions 1034 returns a value through API 1032 in response to an API call from API-calling instructions 1026. While API 1032 defines the syntax and result of an API call (e.g., how to invoke the API call and what the API call docs), API 1032 might not reveal how implementation instructions 1034 accomplishes the function specified by the API call. Various API calls are transferred via the one or more application programming interfaces between API-calling instructions 1026 and implementation instructions 1034. Transferring the API calls can include issuing, initiating, invoking, calling, receiving, returning, and/or responding to the function calls or messages. In other words, transferring can describe actions by either of API-calling instructions 1026 or implementation instructions 1034. In some embodiments, a function call or other invocation of API 1032 sends and/or receives one or more parameters through a parameter list or other structure.

In some embodiments, implementation instructions 1034 provides more than one API, each providing a different view of or with different aspects of functionality implemented by implementation instructions 1034. For example, one API of implementation instructions 1034 can provide a first set of functions and can be exposed to third party developers, and another API of implementation instructions 1034 can be hidden (e.g., not exposed) and provide a subset of the first set of functions and also provide another set of functions, such as testing or debugging functions which are not in the first set of functions. In some embodiments, implementation instructions 1034 calls one or more other components via an underlying API and thus be both an set of API calling instructions and a set of implementation instructions. It should be recognized that implementation instructions 1034 can include additional functions, methods, classes, data structures, and/or other features that are not specified through API 1032 and are not available to API calling instructions 1026. It should also be recognized that API calling instructions 1026 can be on the same system as implementation instructions 1034 or can be located remotely and access implementation instructions 1034 using API 1032 over a network. In some embodiments, implementation instructions 1034, API 1032, and/or API-calling instructions 1026 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, process 500 and/or 600 (FIG. 5, FIG. 6) is performed at a first computer system (as described herein) via a system process (e.g., an operating system process, a server system process) that is different from one or more applications executing and/or installed on the first computer system.

In some embodiments, process 500 and/or 600 (FIG. 5, FIG. 6) is performed at a first computer system (as described herein) by an application that is different from a system process. In some embodiments, the instructions of the application, when executed, control the first computer system to perform process 500 and/or 600 (FIG. 5, FIG. 6) by calling an application programming interface (API) provided by the system process. In some embodiments, the application performs at least a portion of process 500 and/or 600 without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform process 500 and/or 600 (FIG. 5, FIG. 6) by calling an application programming interface (API) provided by the system process using one or more parameters.

In some embodiments, at least one API is a software module (e.g., a collection of computer-readable instructions) that provides an interface that allows a different set of instructions (e.g., API calling instructions) to access and use one or more functions, methods, procedures, data structures, classes, and/or other services provided by a set of implementation instructions of the system process. The API can define one or more parameters that are passed between the API calling instructions and the implementation instructions.

An API that can be called, for example, can correspond to an API provided to manipulate languages, an API provided to split a word element into grapheme clusters, an API provided to apply transform definitions, an API provided to interact with messaging elements, and/or an API provided to perform animations, one or more of which can be used in conjunction with the processes and features described above.

As described above, in some embodiments, the application controls the first computer system to perform process 500 and/or 600 (FIG. 5, FIG. 6) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, the API 1032 defines a first API call that can be provided by API calling instructions 1026, wherein the definition for the first API call specifies the relevant call parameters according to those variables and elements discussed above.

In some embodiments, the API 1032 defines a first API call response that can be provided to the application by API calling instructions 1026, wherein the first API call response provides responsive communications and outputs corresponding to the processes discussed above.

In some embodiments, the set of implementation instructions is a system software module (e.g., a collection of computer-readable instructions) that is constructed to perform an operation in response to receiving an API call via the API. In some embodiments, the set of implementation instructions is constructed to provide an API response (via the API) as a result of processing an API call. In some embodiments, the set of implementation instructions is included in the device (e.g., 1020) that runs the application. In some embodiments, the set of implementation instructions is included in an electronic device that is separate from the device that runs the application.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A device comprising:
a processor; and
a computer-readable memory storing instructions which cause the processor to:
receive, at an input element of a messaging application, a text input including a word;
select the word from the text input for application of an effect;
associate an effect to the word, the effect comprising a text effect, wherein executing the effect alters a display of the word according to the effect;
apply the effect to the word in the input element to execute the effect;
send a message to another device, the message including the word with the effect associated with the word;
move a display of the text input from the input element to a transcript element of the messaging application; and
apply the effect to the word in the transcript element.

2. The device of claim 1, wherein the instructions further cause the processor to:
in response to receiving the text input including the word, analyze the text input by a pattern matching engine or a machine learning model, wherein the word is selected from the text input for association of the effect to the word based on the analysis; and
display the word in an effects suggestion element of the messaging application while applying the effect to the word in the effects suggestion element, or
apply the effect to the word in the input element.

3. The device of claim 2, wherein the instructions further cause the processor to:
when the word is displayed in the effects suggestion element, display the word in multiple instances of the word in the effects suggestion element while applying a unique effect to each instance of the word in the effects suggestion element.

4. The device of claim 1, wherein the effect is a dynamic effect causing the word to be animated, a static effect altering a display characteristic of the word, or both a dynamic effect and a static effect.

5. The device of claim 1, wherein the instructions further cause the processor to:
receive a cursor input in the input element, the cursor input indicating a position of a cursor relative to the text input, wherein the word is selected from the text input for association of the effect based on the position of the cursor, wherein the word following the cursor is selected when the cursor is positioned immediately before the word, wherein the word preceding the cursor is selected when the cursor is positioned immediately after the word, and wherein the word on either side of the cursor is selected when the cursor is positioned between a first symbol of the word and a last symbol of the word.

6. The device of claim 1, wherein the instructions further cause the processor to:
receive an input indicating a selection of an effects menu;
display the word in the effects menu, wherein the effects menu includes a demonstration of one or more available effects, the demonstration including each of the one or more available effects applied to the word in the effects menu; and
receive an input indicating a selection of a selected effect of the one or more available effects, wherein the effect comprises the selected effect and associating the effect to the word is performed in response to receiving the input indicating the selection.

7. The device of claim 1, wherein the effect includes an animation sequence applied to the display of the word, wherein sending the message occurs during the animation sequence being applied to the display of the word, wherein the instructions further cause the processor to:
pause the animation sequence prior to moving the display of the text input from the input element to the transcript element; and
resume the animation sequence after moving the display of the text input to the transcript element.

8. The device of claim 1, wherein the word is written in a language or font utilizing a connected script, wherein the instructions further cause the processor to:
while executing the effect on the word, adjust grapheme clusters corresponding to the word so that consecutive grapheme clusters stay connected.

9. A method comprising:
displaying a message transcript in a messaging application, the message transcript including one or more messages sent or received, the message transcript including an indication of one or more effects that are respectively associated with one or more words of the message transcript; and
applying the one or more effects to the respectively associated one or more words, wherein applying the one or more effects executes the one or more effects on the respectively associated one or more words, wherein executing an effect on a word includes altering a display of a corresponding word according to the effect, wherein altering the display of the word comprises applying a time sequence animation associated with the effect to the word.

10. The method of claim 9, further comprising:
receiving a new message at the messaging application, the new message including a text portion and an indication of one or more new effects respectively associated with one or more new words of the text portion;
cancelling a currently executing effect in the message transcript;
adding the new message to the message transcript; and
applying each of the one or more new effects to the respectively associated one or more new words in the new message.

11. The method of claim 10, wherein cancelling the current execution of the effect comprises applying spring physics to the current execution of the effect to bring the current execution of the effect from a first state to a second state, the first state being mid-execution of the effect, the second state being post execution of the effect.

12. The method of claim 9, wherein executing the one or more effects is performed in succession in an order displayed in the message transcript, wherein after executing a last effect in the message transcript, the executing the one or more effects is performed again, the method further comprising:
after executing a first effect of the one or more effects corresponding to a first message group, waiting a predetermined time before executing a next effect of the one or more effects corresponding to a second message group following the first message group.

13. The method of claim 9, further comprising: executing a first effect on a first word in the message transcript, the first word written in a language or font utilizing a connected script, wherein the executing the first effect is performed so that the connected script remains connected during the execution of the first effect on the first word.

14. The method of claim 9, further comprising:
executing a first effect on a first word in the message transcript; and
before completing the execution of the first effect on the first word, beginning execution of a second effect on a second word in the message transcript.

15. The method of claim 14, wherein execution of the second effect is begun when the execution of the first effect reaches a trigger point during the execution of the first effect.

16. The method of claim 9, further comprising:
receiving, while executing a first effect of the one or more effects, an input indicating an instruction to scroll the message transcript;
pausing the execution of the first effect;
preserving a state of the execution of the first effect;
scrolling the message transcript; and
when a word corresponding to the paused execution of the first effect remains displayed after scrolling, resuming the execution of the first effect based on the preserved state of the execution of the first effect; and
when the word corresponding to the paused execution of the first effect is scrolled out of display view, executing a second effect of the one or more effects.

17. The method of claim 9, wherein each of the one or more effects corresponds to a time sequenced transform per grapheme cluster of a corresponding word, wherein each of the time sequenced transforms comprises a combination of translation, scale, rotation, and stretch for each grapheme cluster.

18. The method of claim 9, wherein at least one of the words associated with a first effect of the one or more effects comprises a combination of glyphs, wherein each of the glyphs comprises a combination of subcomponents, wherein a presentation of each subcomponent of the combination of subcomponents is separately altered during executing the first effect.

19. The method of claim 9, further comprising:
executing a first effect of the one or more effects on a first word in the message transcript, wherein during executing the first effect, adjusting a placement of a static word which is adjacent to the first word using a compositor to recomposite a display output during the executing of the first effect.

20. A non-transitory computer-readable medium storing instructions thereon, which when executed by one or more processors, cause the one or more processors to:
obtain first information based on a user input to a messaging application;
provide the first information based on the user input to the messaging application to an operating system; and
in response to providing the first information to the operating system, receive second information, wherein the second information is a suggested animation for an animated text effect, wherein the first information is information based on a user selection or content of the user selection.
